(19) United States
(12) Patent Application Publication
(10) Pub. No.: US 2015/0280555 A1
(43) Pub. Date: Oct. 1, 2015

(54) PULSE FREQUENCY MODULATION SWITCHING STRATEGY FOR COUPLED INDUCTOR VOLTAGE REGULATORS

(71) Applicant: HENRY W. KOERTZEN, Olympia, WA (US)

(72) Inventor: HENRY W. KOERTZEN, Olympia, WA (US)

(21) Appl. No.: 14/229,850

(22) Filed: Mar. 29, 2014

(51) Int. Cl. H02M 3/156; G06F 1/28

(52) U.S. Cl. CPC H02M 3/156; G06F 1/28

(57) ABSTRACT

Methods and apparatus relating to pulse frequency modulation switching strategy for coupled inductor Voltage Regulators (VRs) are described. In an embodiment, logic is to cause a voltage converter (having at least a first switching phase for a first portion of a plurality of inductors and a second switching phase for a second portion of the plurality of inductors) to delay the second switching phase from the first switching phase. The plurality of inductors are magnetically coupled to each other. Other embodiments are also disclosed and claimed.

### FIELD

The present disclosure generally relates to the field of electronics. More particularly, an embodiment of the invention relates to pulse frequency modulation switching strategy for coupled inductor Voltage Regulators (VRs).

### BACKGROUND

One of the main challenges facing voltage regulator (VR) design is conversion efficiency, especially for mobile platforms where there could be as much as a thousand times difference between peak and standby power consumption. The VR has to convert power efficiently at say 1 A as well as 1 mA. It is very common for VR therefore to have several operating modes as it moves through the load current range. Hence, the conversion efficiency of these several VR operating modes is of paramount importance to general operation of battery-powered, mobile computing devices.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 12-14 illustrate block diagrams of embodiments of computing systems, which may be utilized to implement various embodiments discussed herein.

FIG. 2 illustrates a circuit diagram of a multi-phase coupled-inductor buck converter, according to an embodiment.

FIG. 3 illustrates a sample efficiency curve in PWM mode, according to an embodiment.

FIGS. 4-11 illustrate waveforms and efficiency curves for various PFM switching strategies, according to some embodiments.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

As discussed above, a VR has to convert power efficiently at say 1 A as well as 1 mA. It is very common for VR therefore to have several operating modes as it moves through the load current range. Generally, Pulse Width Modulation (PWM) may be used at higher currents and Pulse Frequency Modulation (PFM) at lower currents. PFM is more efficient at low currents due to the switching frequency reducing with current, but the maximum amount of current that can be supported is limited. The vast majority of VRs are multi-phase buck converters using discrete inductors. As discussed herein, a “buck” converter generally refers to a voltage converter that transforms an input voltage to an output voltage in a ratio that is smaller than unity.

Moreover, some VRs include on-die magnetic inductors, but these VRs may use coupled inductors, e.g., due to the smaller volume that topology enables. The coupled inductors in turn require a new switching strategy for the bridge FETs (Field-Effect Transistors) since the strategy used for uncoupled inductors does not provide adequate efficiency.

Some embodiments provide Pulse Frequency Modulation (PFM) switching strategy for coupled inductor Voltage Regulators (VRs). As previously mentioned, coupled inductors (e.g., on die) may be used to save space, e.g., since coupled inductors can be about five times smaller than equivalent uncoupled inductors. However, this leads to some additional challenges, one being the switching strategy for the PFM mode. To this end, some embodiments provide PFM switching strategies for multi-phase coupled-inductor buck converters. Such techniques optimize the efficiency in PFM mode, and by doing so extend the battery life for mobile devices. As discussed herein, “coupled inductors” generally refer to two or more inductors that are magnetically coupled to each other.

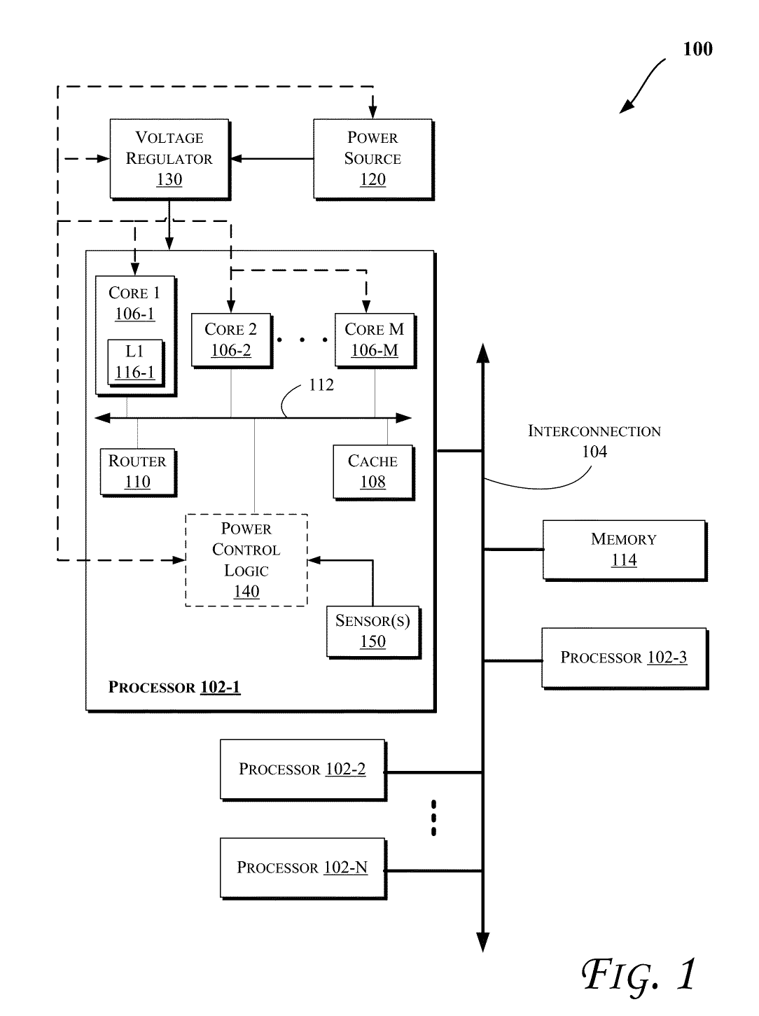

Moreover, some embodiments may be applied in computing systems that include one or more processors (e.g., with one or more processor cores), such as those discussed with reference to FIGS. 1-14, including for example mobile computing devices such as a smartphone, tablet, UMPC (Ultra-Mobile Personal Computer), laptop computer, Ultrabook™ computing device, smart watch, smart glasses, wearable devices, etc. More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

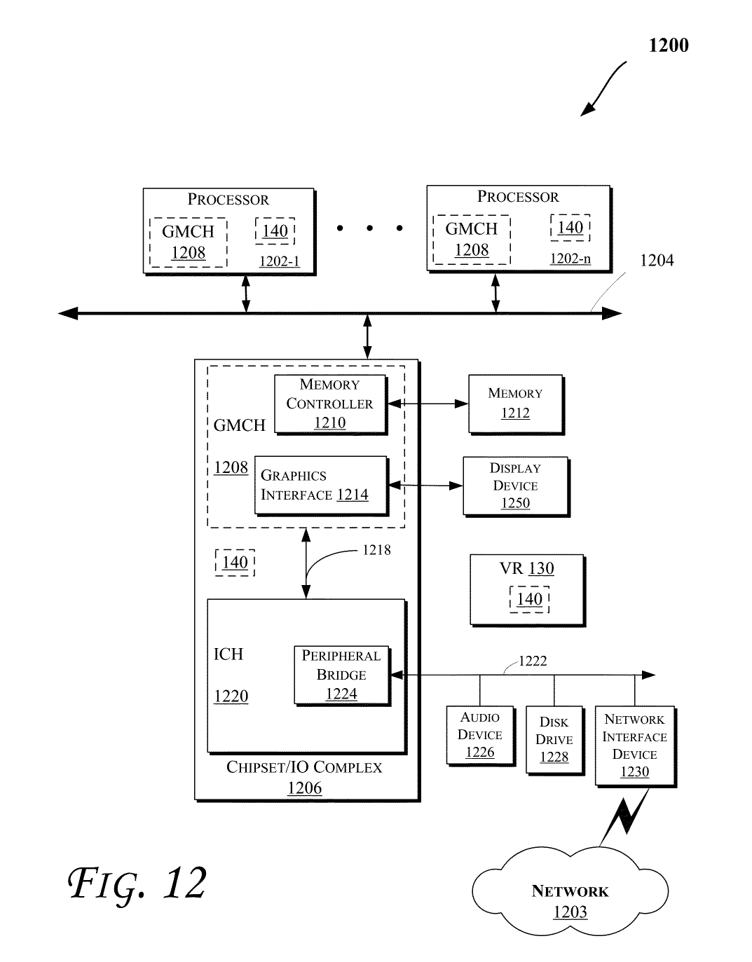

In an embodiment, the processor 102-1 may include one or more processor cores 106-1 through 106-M (referred to herein as “cores 106,” or “core 106”), a cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), graphics and/or memory controllers (such as those discussed with reference to FIGS. 12-14), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102 (e.g., faster access by cores 106). As shown in FIG. 1, the memory 114 may communicate with the processors 102 via the interconnection 104. In an embodiment, the cache 108 (that may be shared) may be a mid-level cache (MLC), a last level cache (LLC), etc. Also, each of the cores 106 may include a level 1 (L1) cache (116-1) (generally referred to herein as “L1 cache 116”) or other levels of cache such as a level 2 (L2) cache. Moreover, various components of the processor 102-1 may communicate with the cache 108 directly, through a bus (e.g., the bus 112), and/or a memory controller or hub.

The system 100 may also include a platform power source 120 (e.g., a direct current (DC) power source or an alternating current (AC) power source) to provide power to one or more components of the system 100. The power source 120 could include a PV (Photo Voltaic) panel, wind generator, thermal generator water/hydro turbine, etc. In some embodiments, the power source 120 may include one or more battery packs (e.g., charged by one or more of a PV panel, wind generator, thermal generator water/hydro turbine, plug-in power supply (e.g., coupled to an AC power grid), etc.) and/or plug-in power supplies. The power source 120 may be coupled to components of system 100 through a voltage regulator (VR) 130. Moreover, even though FIG. 1 illustrates one power source 120 and one voltage regulator 130, additional power sources and/or voltage regulators may be utilized. For example, one or more of the processors 102 may have corresponding voltage regulator(s) and/or power source(s). Also, the voltage regulator(s) 130 may be coupled to the processor 102 via a single power plane (e.g., supplying power to all the cores 106) or multiple power planes (e.g., where each power plane may supply power to a different core or group of cores).

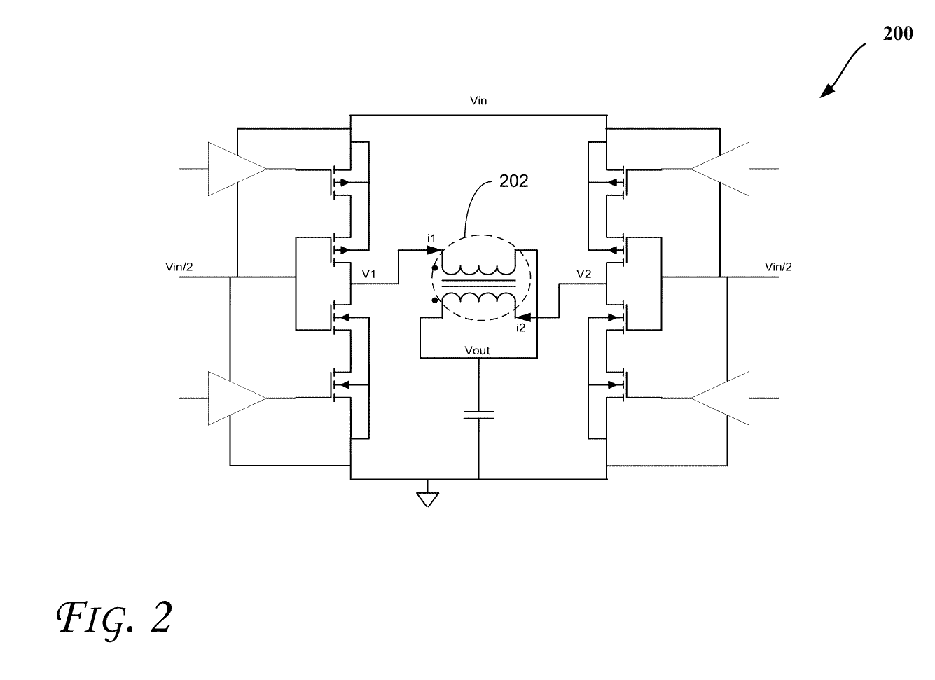

Additionally, while FIG. 1 illustrates the power source 120 and the voltage regulator 130 as separate components, the power source 120 and the voltage regulator 130 may be incorporated into other components of system 100. For example, all or portions of the VR 130 may be incorporated into the power source 120 and/or processor 102. As shown in FIG. 1, system 100 includes a power control logic 140 to control supply of power to components of the processor 102 (e.g., cores 106). In an embodiment, logic 140 may cause invocation (e.g., via one or more signals) of a pulse frequency modulation switching strategy for coupled inductor Voltage Regulators (VRs) 130, e.g., as discussed herein with reference to FIGS. 2-14. Logic 140 may be located in a different location than that shown in FIG. 1 (e.g., outside of processor 102, within VR 130, etc.) and may have access to one or more storage devices discussed herein (such as cache 108, L1 cache 116, memory 114, or another memory in system 100) to store information relating to operations of logic 140 such as information communicated with various components of system 100 as discussed here. As shown, the logic 140 may be coupled to or be implemented within the VR 130 and/or other components of system 100 such as the cores 106 and/or the power source 120.

Additionally, the logic 140 may be coupled to receive information (e.g., in the form of one or more bits or signals) to indicate status of one or more sensors 150. The sensor(s) 150 may be provided proximate to components of system 100 (or other computing systems discussed herein such as those discussed with reference to other figures including 12-14, for example), such as the cores 106, interconnections 104 or 112, components outside of the processor 102, etc., to sense variations in various factors affecting power/thermal behavior of the system/platform, such as temperature, operating frequency, operating voltage, power consumption, and/or inter-core communication activity, etc.

The logic 140 may in turn instruct the VR 130, power source 120, and/or individual components of system 100 (such as the cores 106) to modify their operations. For example, logic 140 may indicate to the VR 130 and/or power source 120 (or PSU) to adjust their output or operations. Also, even though components 140 and 150 are shown to be included in processor 102-1, these components may be provided elsewhere in the system 100. For example, power control logic 140 may be provided in the VR 130, in the power source 120, directly coupled to the interconnection 104, within one or more (or alternatively all) of the processors 102, outside of computing device/system (e.g., as a standalone device), coupled to (or integrated with) the power source 120, etc. Furthermore, as shown in FIG. 1, the power source 120 and/or the voltage regulator 130 may communicate with the power control logic 140 and report their power specification.

FIG. 2 illustrates a circuit diagram of a multi-phase coupled-inductor buck converter 200, according to an embodiment. As shown in FIG. 2, the buck converter 200 has two switching phases, e.g., a first switching phase and a second switching phase. Further, even though a double stack design is shown in FIG. 2 (e.g., for the voltage rating), a single stack (or three stack or higher) design may also be used. The saturation current is lower than that for uncoupled inductors, so both phases always need to be switching to produce opposing magnetic fields. Coupled inductors 202 are saturated by the magnetizing current (i_{M}) which can be to the first order (due to the generally high coupling factor) and be defined as the net current through the structure, and is given by i_{M}=i1-i2 in the schematic. Voltages V1 and V2 are generated by corresponding stacks of FETs on either side of the converter 200 based on input voltage (Vin).

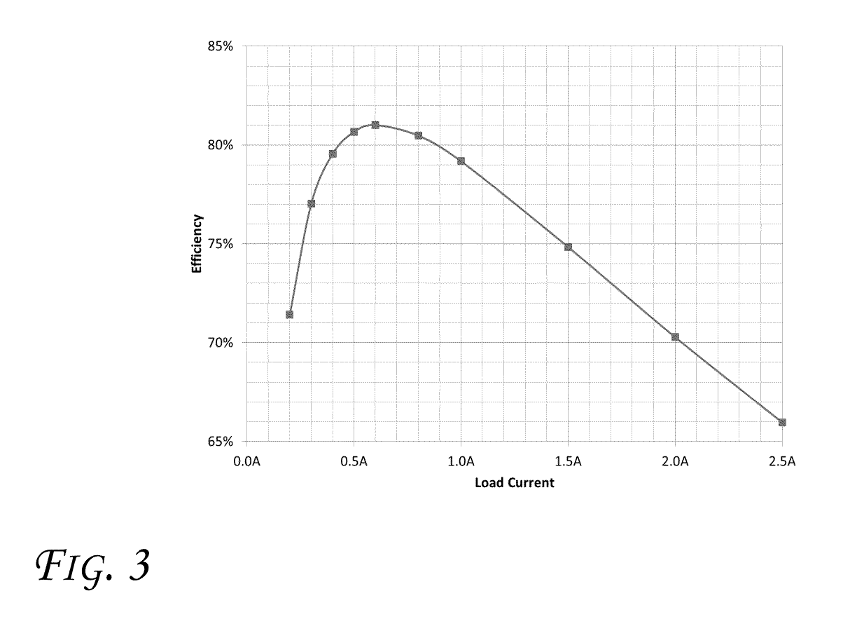

FIG. 3 illustrates a sample efficiency curve in PWM mode, according to an embodiment. As illustrated, the peak efficiency is about 81% at 600 mA. Ideally the PFM mode would be enabled below 600 mA and the efficiency would remain at 81% down to the mA range when the controller power loss will start to become dominant and start to decrease the efficiency.

Referring to FIGS. 2-3, the PFM switching strategy is relatively straight forward for uncoupled converters. Only one phase needs to be pulsed. For example, the upper FET is turned on and the inductor current will start ramping up from zero. When the current reaches the desired level (below the saturation current value), the upper FET is turned off and the lower FET is turned on. The inductor current then ramps back down and the lower FET is turned off when it reaches zero. Both upper and lower FETs then remain off until the control logic determines it is time for the next pulse to maintain the output voltage. As the load current decreases, the frequency of the pulses will also decrease which is why a PFM efficiency curve is flat horizontally.

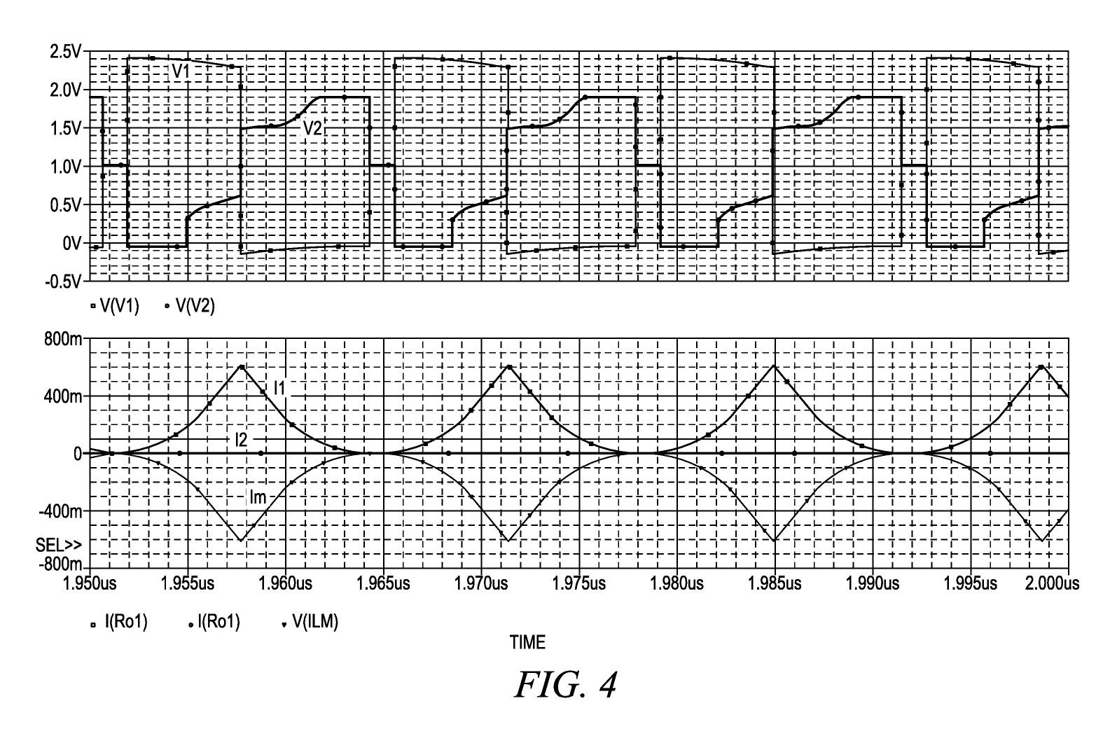

There are two other variables that can impact the efficiency in PFM mode: the size of the FETs and the peak inductor current. These need to be optimized to obtain the best efficiency. The PFM efficiency graphs shown sweeps these to determine the best operating point. However, as the peak inductor current is reduced the maximum current that can be supported by PFM is also reduced. To this end, multiple PFM switching strategies (e.g., implemented via logic 140 in some embodiments) will be next discussed herein with the corresponding waveforms and efficiency curves in reference to FIGS. 4-11.

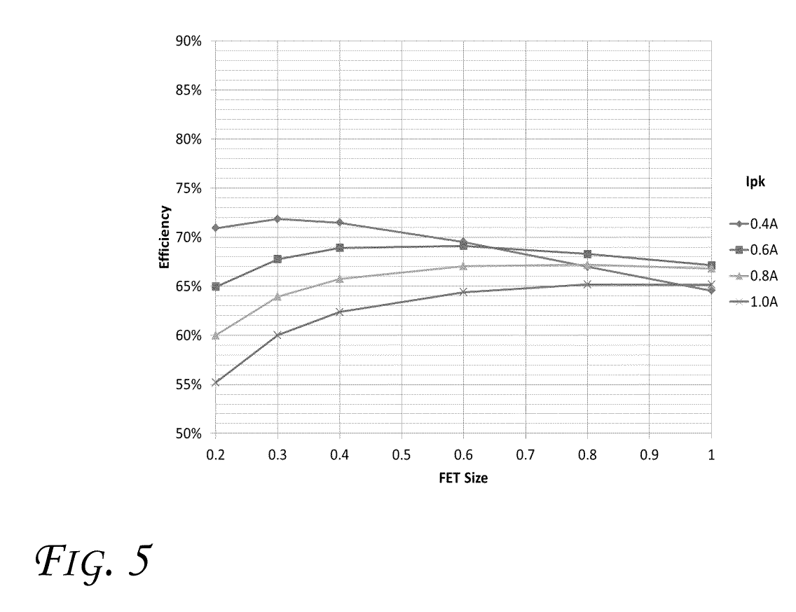

FIGS. 4-5 illustrate waveforms and efficiency curves for a PFM switching strategy, according to some embodiments. More particularly, FIG. 4 shows voltage and current waveforms and FIG. 5 shows efficiency as a function of relative FET size and peak inductor current, according to a first PFM switching strategy.

The strategy discussed with reference to FIGS. 4-5 may be the same or similar to the strategy that can be used for uncoupled inductor topologies. Referring to FIGS. 2 and 4-5, only phase 1 is switched. The coupled inductor saturates early on due to i_{M}=i1. That, combined with the lower inductance to start with compared to uncoupled inductors, results in a low efficiency. About 72% efficiency (in this example) for a peak inductor current (“Ipeak” or “Ipk”) of 0.3 A which will only sustain a load current of about 100 mA. To support a 600 mA load current, the peak would have to be beyond 1200 mA and the efficiency will be well below 70%.

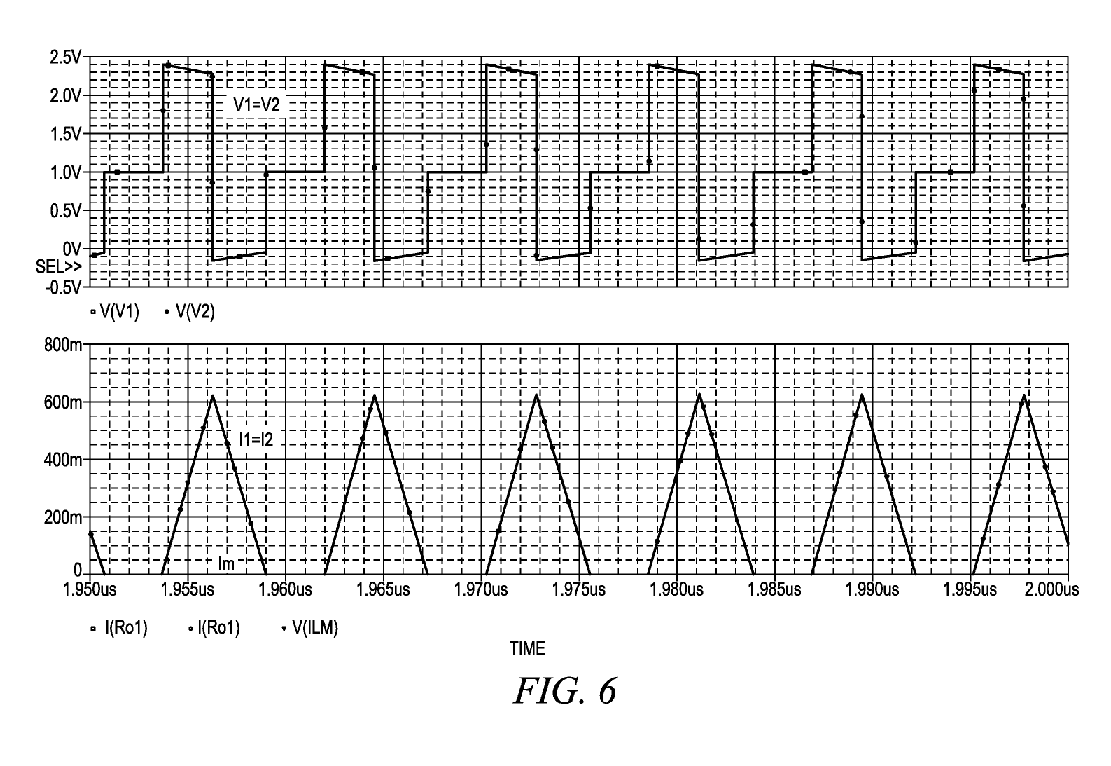

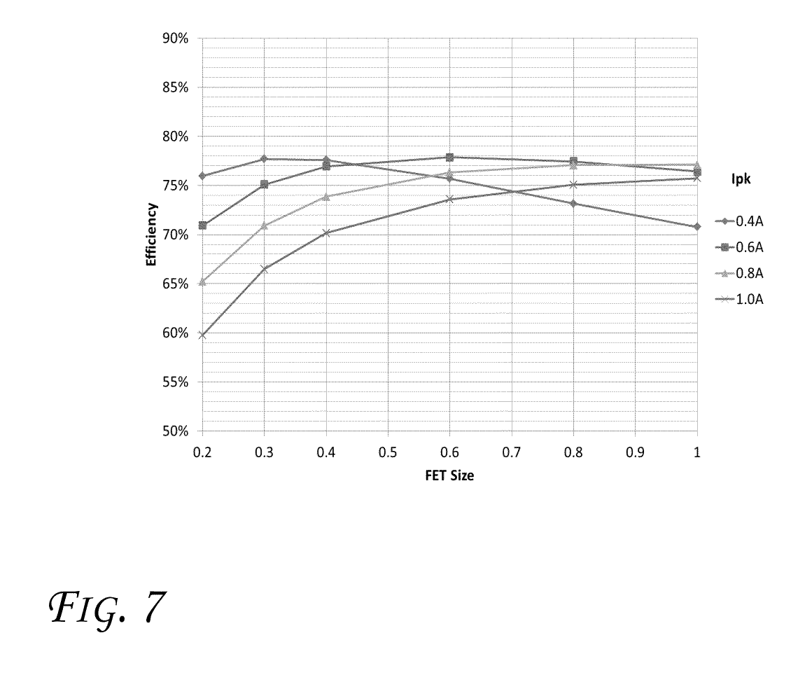

FIGS. 6-7 illustrate waveforms and efficiency curves for a PFM switching strategy, according to some embodiments. More particularly, FIG. 6 shows voltage and current waveforms and FIG. 7 illustrates efficiency as a function of relative FET size and peak inductor current, according to a second PFM switching strategy.

Referring to FIGS. 2 and 6-7, both the bridges (which is the term used for the combination of the upper and lower switches (FETs in this case)—and as we now know for PFM, the upper switch conducts first and then the lower switch) are switched at the substantially the same time/instant and for substantially the same duration. This gives a significant improvement in the efficiency to about 78%. There is no first order magnetizing current and as a result no saturation. The 600 mA peak current will support a 600 mA load since the current waveforms are relatively linear and there are two phases switching (with 1200 mA total peak).

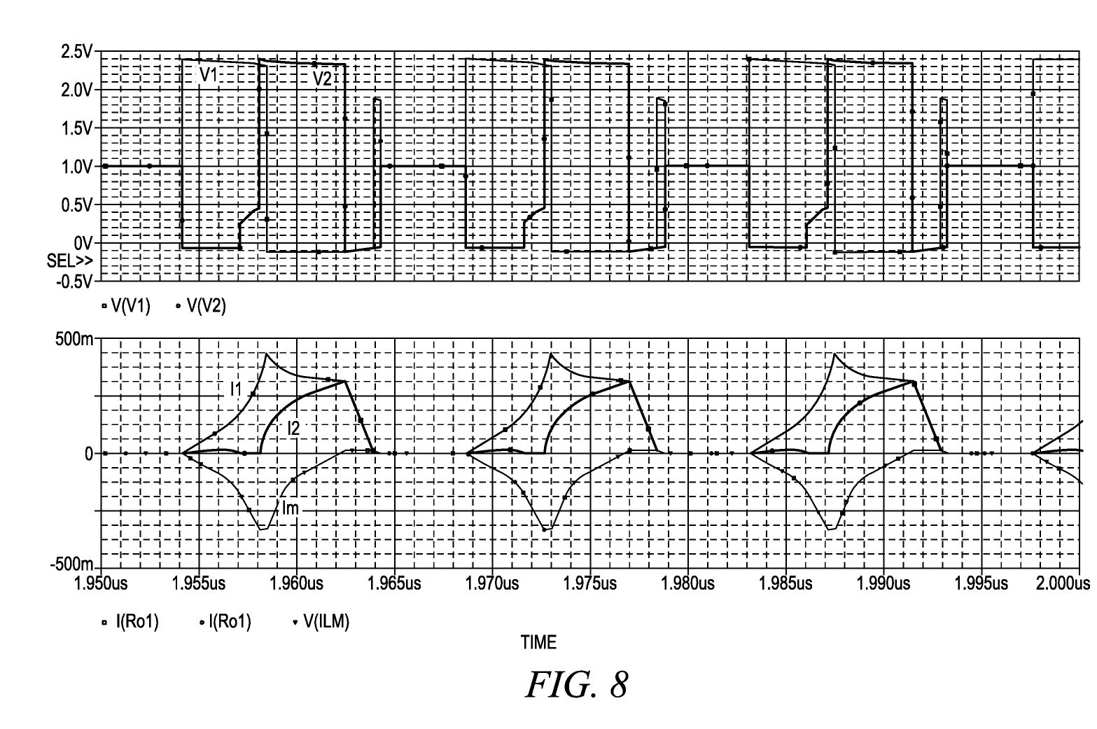

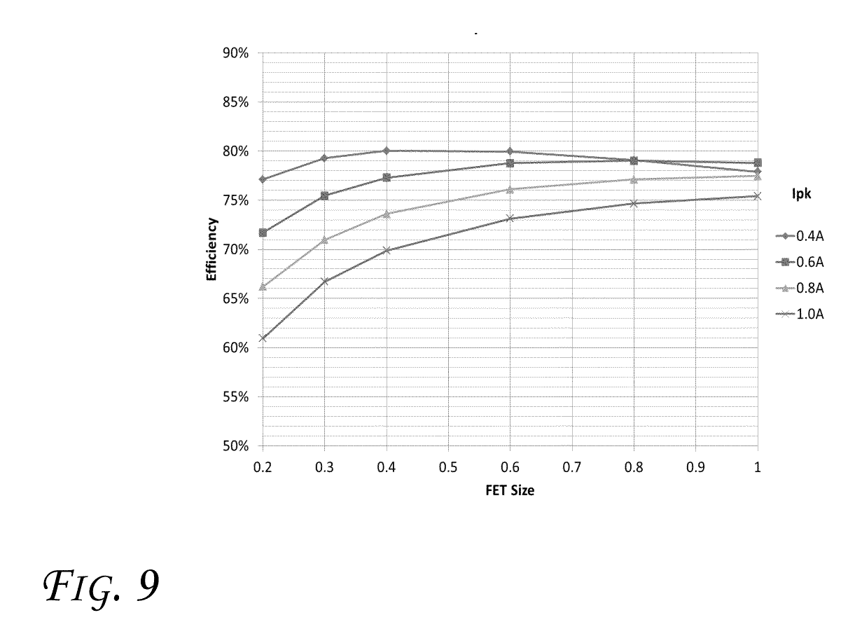

FIGS. 8-9 illustrate waveforms and efficiency curves for a PFM switching strategy, according to some embodiments. More particularly, FIG. 8 shows voltage and current waveforms and FIG. 9 shows efficiency as a function of relative FET size and peak inductor current, according to a third PFM switching strategy.

Both first and second phases are still switched for the same duration but now phase 2 is slightly delayed from phase 1. This results in i_{M} being excited in one direction and more energy being transferred per pulse (i.e., a wider current pulse for the same peak current value). This increases the efficiency for this example from about 78% (for strategy discussed with reference to FIGS. 6-7) to about 80%.

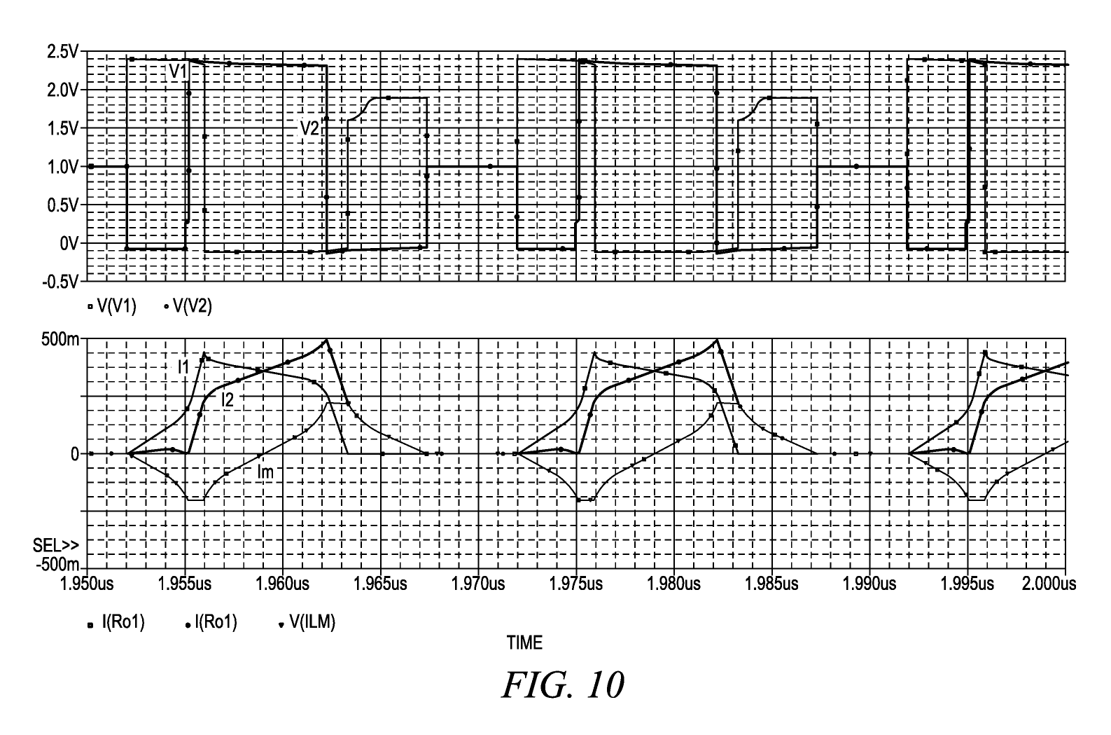

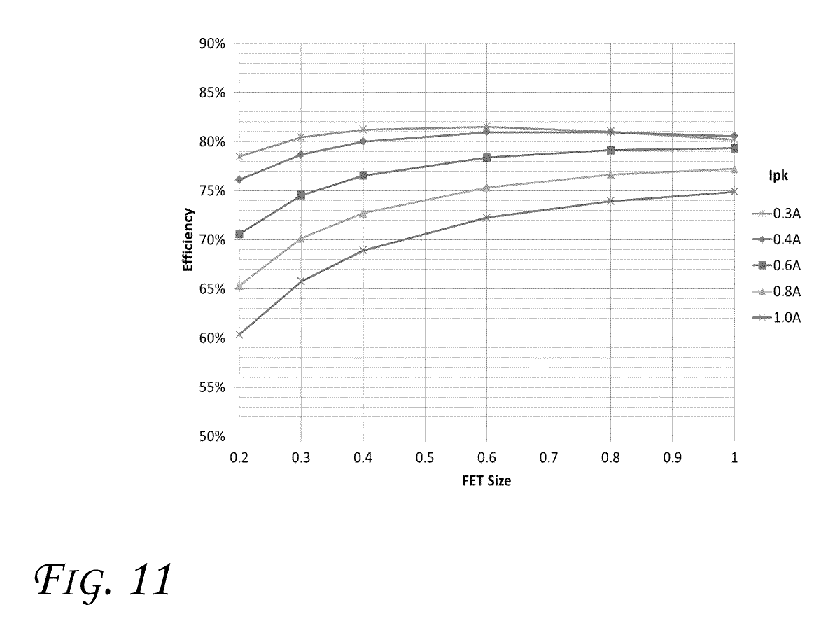

FIGS. 10-11 illustrate waveforms and efficiency curves for a PFM switching strategy, according to some embodiments. More particularly, FIG. 10 shows voltage and current waveforms and FIG. 11 shows efficiency as a function of relative FET size and peak inductor current, according to a fourth PFM switching strategy.

Referring to FIGS. 2 and 10-11, phase 2 is still delayed from phase 1, but the duration is also increased beyond that of phase 1. This results in i_{M} being excited in both directions and even more energy is transferred per pulse. This increases the efficiency to about 81% (at Ipk of about 0.4 A and relative FET size of about 0.6 to 0.8) which is in line with the peak PWM efficiency.

As for battery life impact, the relationship between Battery Life (BL) and efficiency (η) is given by:

$$\frac{{BL}_{1}}{{BL}_{2}} = \frac{{η}_{1}}{{η}_{2}}$$

Hence, going from the first strategy (about 70% or less as discussed with reference to FIGS. 4-5) to the second strategy (about 78% as discussed with reference to FIGS. 6-7) in this example, the battery life would increase by about 11%+. Going further from the second strategy to the fourth strategy (about 81% as discussed with reference to FIGS. 10-11) would increase the battery life again by about 4% which in itself is significant.

FIG. 12 illustrates a block diagram of a computing system 1200 in accordance with an embodiment. The computing system 1200 may include one or more Central Processing Units (CPUs) 1202 or processors that communicate via an interconnection network (or bus) 1204. The processors 1202 may include a general purpose processor, a network processor (that processes data communicated over a computer network 1203), or other types of a processor (including a reduced instruction set computer (RISC) processor or a complex instruction set computer (CISC)).

Moreover, the processors 1202 may have a single or multiple core design. The processors 1202 with a multiple core design may integrate different types of processor cores on the same integrated circuit (IC) die. Also, the processors 1202 with a multiple core design may be implemented as symmetrical or asymmetrical multiprocessors. In an embodiment, one or more of the processors 1202 may be the same or similar to the processors 102 of FIG. 1. Further, one or more components of system 1200 may include VR 130, logic 140 coupled to sensor(s) 150 (not shown in FIG. 12) discussed with reference to FIGS. 1-11 (including but not limited to those locations illustrated in FIG. 12). Also, the operations discussed with reference to FIGS. 1-11 may be performed by one or more components of the system 1200.

A chipset 1206 may also communicate with the interconnection network 1204. The chipset 1206 may include a graphics memory control hub (GMCH) 1208, which may be located in various components of system 1200 (such as those shown in FIG. 12). The GMCH 1208 may include a memory controller 1210 that communicates with a memory 1212 (which may be the same or similar to the memory 114 of FIG. 1). The memory 1212 may store data, including sequences of instructions, that may be executed by the CPU 1202, or any other device included in the computing system 1200. In one embodiment, the memory 1212 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 1204, such as multiple CPUs and/or multiple system memories.

The GMCH 1208 may also include a graphics interface 1214 that communicates with a display device 1250. In one embodiment, the graphics interface 1214 may communicate with the display device 1250 via an accelerated graphics port (AGP) or Peripheral Component Interconnect (PCI) (or PCI express (PCIe) interface). In an embodiment, the display (such as a flat panel display) may communicate with the graphics interface 1214 through, for example, a signal converter that translates a digital representation of an image stored in a storage device such as video memory or system memory into display signals that are interpreted and displayed by the display device. The display signals produced may pass through various control devices before being interpreted by and subsequently displayed on the display device 1250.

A hub interface 1218 may allow the GMCH 1208 and an input/output control hub (ICH) 1220 to communicate. The ICH 1220 may provide an interface to I/O device(s) that communicate with the computing system 1200. The ICH 1220 may communicate with a bus 1222 through a peripheral bridge (or controller) 1224, such as a peripheral component interconnect (PCI) bridge, a universal serial bus (USB) controller, or other types of peripheral bridges or controllers. The bridge 1224 may provide a data path between the CPU 1202 and peripheral devices. Other types of topologies may be utilized. Also, multiple buses may communicate with the ICH 1220, e.g., through multiple bridges or controllers. Moreover, other peripherals in communication with the ICH 1220 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 1222 may communicate with an audio device 1226, one or more disk drive(s) 1228, and a network interface device 1230 (which is in communication with the computer network 1203). Other devices may communicate via the bus 1222. Also, various components (such as the network interface device 1230) may communicate with the GMCH 1208 in some embodiments. In addition, the processor 1202 and the GMCH 1208 may be combined to form a single chip. Furthermore, a graphics accelerator may be included within the GMCH 1208 in other embodiments.

Furthermore, the computing system 1200 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 1228), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

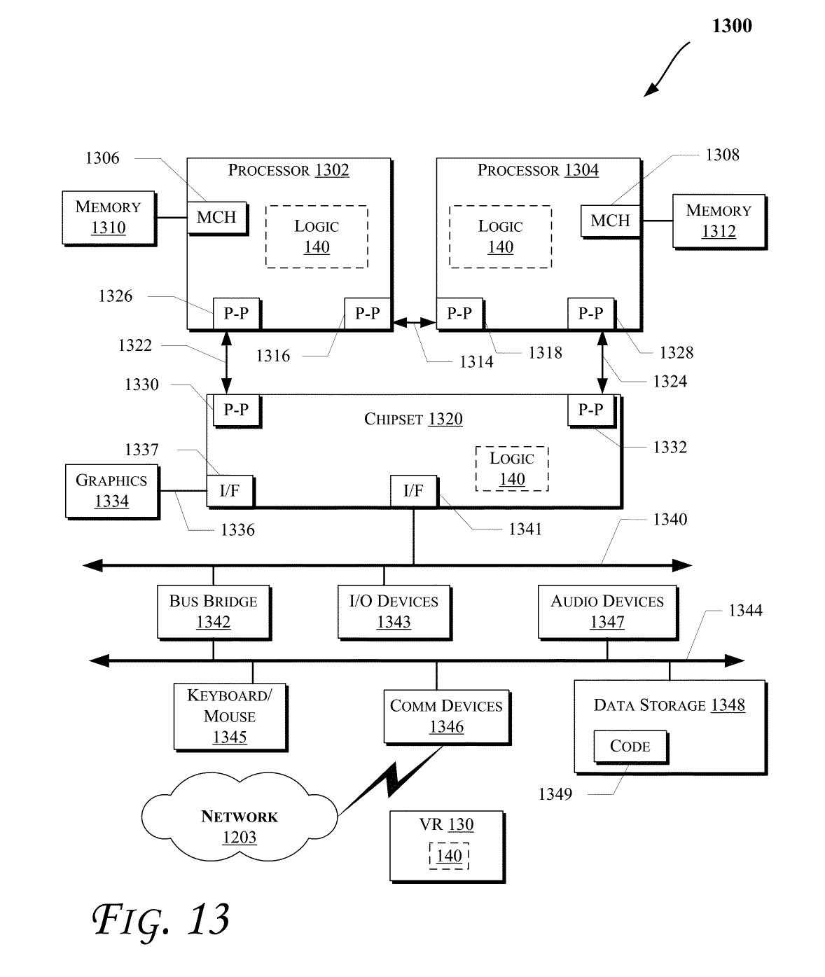

FIG. 13 illustrates a computing system 1300 that is arranged in a point-to-point (PtP) configuration, according to an embodiment of the invention. In particular, FIG. 13 shows a system where processors, memory, and input/output devices are interconnected by a number of point-to-point interfaces. The operations discussed with reference to FIGS. 1-12 may be performed by one or more components of the system 1300. For example, a voltage regulator (such as VR 130 of FIG. 1) and/or logic 140 may regulate or control the voltage supplied to one or more components of FIG. 13.

As illustrated in FIG. 13, the system 1300 may include several processors, of which only two, processors 1302 and 1304 are shown for clarity. The processors 1302 and 1304 may each include a local memory controller hub (MCH) 1306 and 1308 to enable communication with memories 1310 and 1312. The memories 1310 and/or 1312 may store various data such as those discussed with reference to the memory 1212 of FIG. 12. Also, the processors 1302 and 1304 may include one or more of the cores 106, logic 140, and/or sensor(s) 150 of FIG. 1.

In an embodiment, the processors 1302 and 1304 may be one of the processors 1202 discussed with reference to FIG. 12. The processors 1302 and 1304 may exchange data via a point-to-point (PtP) interface 1314 using PtP interface circuits 1316 and 1318, respectively. Also, the processors 1302 and 1304 may each exchange data with a chipset 1320 via individual PtP interfaces 1322 and 1324 using point-to-point interface circuits 1326, 1328, 1330, and 1332. The chipset 1320 may further exchange data with a high-performance graphics circuit 1334 via a high-performance graphics interface 1336, e.g., using a PtP interface circuit 1337.

In at least one embodiment, one or more operations discussed with reference to FIGS. 1-13 may be performed by the processors 1302 or 1304 and/or other components of the system 1300 such as those communicating via a bus 1340. Other embodiments of the invention, however, may exist in other circuits, logic units, or devices within the system 1300 of FIG. 13. Furthermore, some embodiments of the invention may be distributed throughout several circuits, logic units, or devices illustrated in FIG. 13.

Chipset 1320 may communicate with the bus 1340 using a PtP interface circuit 1341. The bus 1340 may have one or more devices that communicate with it, such as a bus bridge 1342 and I/O devices 1343. Via a bus 1344, the bus bridge 1342 may communicate with other devices such as a keyboard/mouse 1345, communication devices 1346 (such as modems, network interface devices, or other communication devices that may communicate with the computer network 1203), audio I/O device, and/or a data storage device 1348. The data storage device 1348 may store code 1349 that may be executed by the processors 1302 and/or 1304.

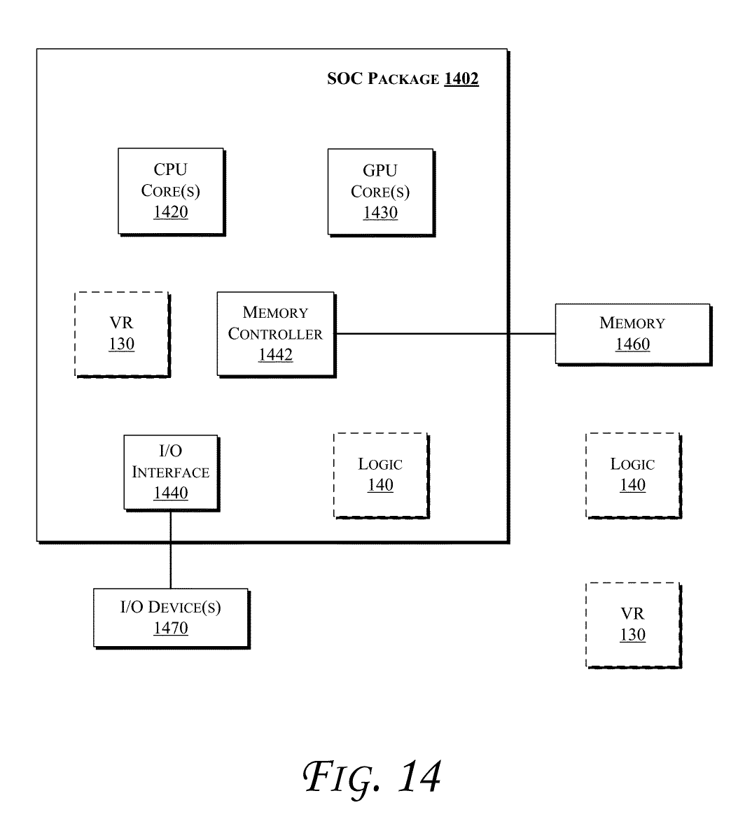

In some embodiments, one or more of the components discussed herein can be embodied as a System On Chip (SOC) device. FIG. 14 illustrates a block diagram of an SOC package in accordance with an embodiment. As illustrated in FIG. 14, SOC 1402 includes one or more Central Processing Unit (CPU) cores 1420, one or more Graphics Processor Unit (GPU) cores 1430, an Input/Output (I/O) interface 1440, and a memory controller 1442. Various components of the SOC package 1402 may be coupled to an interconnect or bus such as discussed herein with reference to the other figures. Also, the SOC package 1402 may include more or less components, such as those discussed herein with reference to the other figures. Further, each component of the SOC package 1420 may include one or more other components, e.g., as discussed with reference to the other figures herein. In one embodiment, SOC package 1402 (and its components) is provided on one or more Integrated Circuit (IC) die, e.g., which are packaged into a single semiconductor device.

As illustrated in FIG. 14, SOC package 1402 is coupled to a memory 1460 (which may be similar to or the same as memory discussed herein with reference to the other figures) via the memory controller 1442. In an embodiment, the memory 1460 (or a portion of it) can be integrated on the SOC package 1402.

The I/O interface 1440 may be coupled to one or more I/O devices 1470, e.g., via an interconnect and/or bus such as discussed herein with reference to other figures. I/O device(s) 1470 may include one or more of a keyboard, a mouse, a touchpad, a display, an image/video capture device (such as a camera or camcorder/video recorder), a touch screen, a speaker, or the like. Furthermore, SOC package 1402 may include/integrate the VR 130 and/or logic 140 in an embodiment. Alternatively, the VR 130 and/or logic 140 may be provided outside of the SOC package 1402 (i.e., as a discrete logic).

The following examples pertain to further embodiments. Example 1 includes an apparatus comprising: logic, at least a portion of which is in hardware, to cause a voltage converter, having at least a first switching phase for a first portion of a plurality of inductors and a second switching phase for a second portion of the plurality of inductors, to delay the second switching phase from the first switching phase, wherein the plurality of inductors are to be magnetically coupled to each other. Example 2 includes the apparatus of example 1, wherein a duration of the first switching phase is to be substantially the same as a duration of the second switching phase. Example 3 includes the apparatus of example 1, wherein a duration of the first switching phase is to differ from a duration of the second switching phase. Example 4 includes the apparatus of example 1, wherein the logic is to cause switching of the first switching phase while the second switching phase remains unswitched. Example 5 includes the apparatus of example 1, wherein the plurality of inductors are to comprise on-die magnetic inductors. Example 6 includes the apparatus of example 1, wherein the first and second switching phases are to switch the first portion and the second portion of the plurality of inductors continuously to generate opposing magnetic fields. Example 7 includes the apparatus of example 1, wherein the voltage converter is a buck voltage converter. Example 8 includes the apparatus of example 1, wherein one or more of: the logic, a processor, and memory are on a single integrated circuit.

Example 9 includes a method comprising: causing a voltage converter, having at least a first switching phase for a first portion of a plurality of inductors and a second switching phase for a second portion of the plurality of inductors, to delay the second switching phase from the first switching phase, wherein the plurality of inductors are magnetically coupled to each other. Example 10 includes the method of example 9, wherein a duration of the first switching phase is substantially the same as a duration of the second switching phase. Example 11 includes the method of example 9, wherein a duration of the first switching phase differs from a duration of the second switching phase. Example 12 includes the method of example 9, further comprising causing switching of the first switching phase while the second switching phase remains unswitched. Example 13 includes the method of example 9, wherein the plurality of inductors comprise on-die magnetic inductors. Example 14 includes the method of example 9, further comprising the first and second switching phases switching the first portion and the second portion of the plurality of inductors continuously to generate opposing magnetic fields. Example 15 includes the method of example 9, wherein the voltage converter is a buck voltage converter.

Example 16 includes a computer-readable medium comprising one or more instructions that when executed on a processor configure the processor to perform one or more operations to: cause a voltage converter, having at least a first switching phase for a first portion of a plurality of inductors and a second switching phase for a second portion of the plurality of inductors, to delay the second switching phase from the first switching phase, wherein the plurality of inductors are magnetically coupled to each other. Example 17 includes the computer-readable medium of example 16, wherein a duration of the first switching phase is substantially the same as a duration of the second switching phase. Example 18 includes the computer-readable medium of example 16, wherein a duration of the first switching phase differs from a duration of the second switching phase. Example 19 includes the computer-readable medium of example 16, further comprising one or more instructions that when executed on the processor configure the processor to perform one or more operations to cause switching of the first switching phase while the second switching phase remains unswitched. Example 20 includes the computer-readable medium of example 16, wherein the plurality of inductors comprise on-die magnetic inductors. Example 21 includes the computer-readable medium of example 16, further comprising one or more instructions that when executed on the processor configure the processor to perform one or more operations to switch the first portion and the second portion of the plurality of inductors continuously to generate opposing magnetic fields. Example 22 includes the computer-readable medium of example 16, wherein the voltage converter is a buck voltage converter.

Example 23 includes a system comprising: a processor having one or more processor cores; logic, at least a portion of which is in hardware, to cause a voltage converter coupled to the processor, the voltage converter having at least a first switching phase for a first portion of a plurality of inductors and a second switching phase for a second portion of the plurality of inductors, to delay the second switching phase from the first switching phase, wherein the plurality of inductors are to be magnetically coupled to each other. Example 24 includes the system of example 23, wherein a duration of the first switching phase is to be substantially the same as a duration of the second switching phase. Example 25 includes the system of example 23, wherein a duration of the first switching phase is to differ from a duration of the second switching phase. Example 26 includes the system of example 23, wherein the logic is to cause switching of the first switching phase while the second switching phase remains unswitched. Example 27 includes the system of example 23, wherein the plurality of inductors are to comprise on-die magnetic inductors.

Example 28 includes the system of example 23, wherein the first and second switching phases are to switch the first portion and the second portion of the plurality of inductors continuously to generate opposing magnetic fields. Example 29 includes the system of example 23, wherein the voltage converter is a buck voltage converter. Example 30 includes the system of example 23, wherein one or more of: the logic, a processor, and memory are on a single integrated circuit.

Example 31 includes an apparatus comprising means to perform a method as set forth in any preceding example.

Example 32 includes a machine-readable storage including machine-readable instructions, when executed, to implement a method or realize an apparatus as set forth in any preceding claim.

In various embodiments of the invention, the operations discussed herein, e.g., with reference to FIGS. 1-14, may be implemented as hardware (e.g., logic circuitry), software, firmware, or combinations thereof, which may be provided as a computer program product, e.g., including a tangible machine-readable or computer-readable medium having stored thereon instructions (or software procedures) used to program a computer to perform a process discussed herein. The machine-readable medium may include a storage device such as those discussed with respect to FIGS. 1-14.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
logic, at least a portion of which is in hardware, to cause a voltage converter, having at least a first switching phase for a first portion of a plurality of inductors and a second switching phase for a second portion of the plurality of inductors, to delay the second switching phase from the first switching phase,
wherein the plurality of inductors are to be magnetically coupled to each other.

2. The apparatus of claim 1, wherein a duration of the first switching phase is to be substantially the same as a duration of the second switching phase.

3. The apparatus of claim 1, wherein a duration of the first switching phase is to differ from a duration of the second switching phase.

4. The apparatus of claim 1, wherein the logic is to cause switching of the first switching phase while the second switching phase remains unswitched.

5. The apparatus of claim 1, wherein the plurality of inductors are to comprise on-die magnetic inductors.

6. The apparatus of claim 1, wherein the first and second switching phases are to switch the first portion and the second portion of the plurality of inductors continuously to generate opposing magnetic fields.

7. The apparatus of claim 1, wherein the voltage converter is a buck voltage converter.

8. The apparatus of claim 1, wherein one or more of: the logic, a processor, and memory are on a single integrated circuit.

9. A method comprising:
causing a voltage converter, having at least a first switching phase for a first portion of a plurality of inductors and a second switching phase for a second portion of the plurality of inductors, to delay the second switching phase from the first switching phase,
wherein the plurality of inductors are magnetically coupled to each other.

10. The method of claim 9, wherein a duration of the first switching phase is substantially the same as a duration of the second switching phase.

11. The method of claim 9, wherein a duration of the first switching phase differs from a duration of the second switching phase.

12. The method of claim 9, further comprising causing switching of the first switching phase while the second switching phase remains unswitched.

13. The method of claim 9, wherein the plurality of inductors comprise on-die magnetic inductors.

14. The method of claim 9, further comprising the first and second switching phases switching the first portion and the second portion of the plurality of inductors continuously to generate opposing magnetic fields.

15. The method of claim 9, wherein the voltage converter is a buck voltage converter.

16. A computer-readable medium comprising one or more instructions that when executed on a processor configure the processor to perform one or more operations to:
cause a voltage converter, having at least a first switching phase for a first portion of a plurality of inductors and a second switching phase for a second portion of the plurality of inductors, to delay the second switching phase from the first switching phase,
wherein the plurality of inductors are magnetically coupled to each other.

17. The computer-readable medium of claim 16, wherein a duration of the first switching phase is substantially the same as a duration of the second switching phase.

18. The computer-readable medium of claim 16, wherein a duration of the first switching phase differs from a duration of the second switching phase.

19. The computer-readable medium of claim 16, further comprising one or more instructions that when executed on the processor configure the processor to perform one or more operations to cause switching of the first switching phase while the second switching phase remains unswitched.

20. The computer-readable medium of claim 16, wherein the plurality of inductors comprise on-die magnetic inductors.

21. The computer-readable medium of claim 16, further comprising one or more instructions that when executed on the processor configure the processor to perform one or more operations to switch the first portion and the second portion of the plurality of inductors continuously to generate opposing magnetic fields.

22. The computer-readable medium of claim 16, wherein the voltage converter is a buck voltage converter.

23. A system comprising:
a processor having one or more processor cores;
logic, at least a portion of which is in hardware, to cause a voltage converter coupled to the processor, the voltage converter having at least a first switching phase for a first portion of a plurality of inductors and a second switching phase for a second portion of the plurality of inductors, to delay the second switching phase from the first switching phase,
wherein the plurality of inductors are to be magnetically coupled to each other.

24. The system of claim 23, wherein a duration of the first switching phase is to be substantially the same as a duration of the second switching phase.

25. The system of claim 23, wherein a duration of the first switching phase is to differ from a duration of the second switching phase.
